(19) United States
(12) Patent Application Publication
(10) Pub. No.: US 2025/0045091 A1
(43) Pub. Date: Feb. 6, 2025

(54) LOW LATENCY INTER CORE COMMUNICATION

(71) Applicant: QUALCOMM Incorporated, San Diego, CA (US)

(72) Inventors: Rohan Desai, San Diego, CA (US); Abhilash Shivashankara Pillai, San Diego, CA (US); Rajakumar Govindaram, San Diego, CA (US); Satish Goverdhan, San Diego, CA (US); Pavan Kumar Chilamkurthi, San Diego, CA (US); Wesley James Holland, Encinitas, CA (US)

(21) Appl. No.: 18/364,037

(22) Filed: Aug. 2, 2023

(51) Int. Cl. G06F 9/48; G06F 9/54

(52) U.S. Cl. CPC G06F 9/4812; G06F 9/54

(57) ABSTRACT

A multi-core processing system, such as a system-on-chip (SOC), is configured to use interrupts when sending processed data from a source processing core to a destination processing core. The source processing core may delay sending interrupts, but still keep processing data, when an acknowledgment for a previous interrupt is not received from an inter-processor communication controller. When the acknowledgment is received, the source processing core may resume sending an interrupt for the next chunk of data processed. As such, not all chunks of data may have associated interrupts.

### TECHNICAL FIELD

This disclosure relates to multi-core processing systems, including techniques related to inter processor communication and interrupt handling.

### BACKGROUND

Multi-core processing systems, such as a system-on-chip (SOC), may include multiple processing cores of different types in an integrated circuit (e.g., within a single chip). This configuration allows for the integration of different processing capabilities into a unified system, enabling execution of diverse tasks. For some use cases, a multi-core processing system may use multiple processing cores to process the same set of data (e.g., image data) in succession. Multi-core processing systems may use interrupt controllers or other inter-core communications controllers to facilitate data transfer between processing cores.

### SUMMARY

The present disclosure generally relates to techniques for inter processor communication and interrupt handling. In a multi-core processing system, such as an SOC, two or more processing cores may process the same set of data in succession. As one general example, an image signal processor may process image frames captured by an image sensor. Another processing core, such as a digital signal processor, may then perform post-processing techniques on the image frame processed by the image signal processor. The SOC may include multiple processing cores arranged in a star topology, where communication between the processing cores is handled by a central inter-processor communication controller (IPCC).

The IPCC may receive an interrupt from a source processing core that indicates that data (e.g., a chunk or subset of the total amount data to be processed) has been processed and is available in memory for a destination processing core. The source processing core may also provide to the IPCC an index or other information that identifies the chunk of data relative to other chunks for data. The IPCC may generate an indication to the destination processing core that the chunk of data is available and may further send an acknowledgment back to the source processing core that the interrupt has been processed.

Many SOCs may include a large number of processing cores and may handle a large number of interrupts for some use cases, such as autonomous driving, advanced driver assistance systems (ADAS), virtual reality (VR), and extended reality (XR). In accordance with the techniques of this disclosure, to avoid system slow downs or stalls due to a large number of interrupts, source processing cores may be configured to refrain from sending interrupts when an acknowledgment of a previous interrupt has not been received. The source processing core may continue to process subsequent chunks of data and store the chunks of data to memory, but will not send further interrupts. When an acknowledgment of a previous interrupt has been received from the IPCC, the source processing core will resume sending an interrupt for the most recent chunk of data that has been processed.

As such, consecutive interrupts received by the IPCC may not be for continuous chunks of data. The IPCC may determine that the next interrupt received by the IPCC is not for a continuous chunk of data. In that case, the IPCC may indicate to the destination processing core that multiple chunks of data are now available for processing. By refraining from sending interrupts when the acknowledgment of the previous interrupt is not received, the techniques of this disclosure may avoid overloading the IPCC with interrupts. Also, by continuing to process data while refraining from sending the interrupts, the source processing device may prevent any delays for time sensitive use cases.

In one example, this disclosure describes an apparatus for interrupt handling, the apparatus comprising: one or more memories, and a first processing core coupled to the one or more memories. The first processing core is configured to process a first chunk of data, generate a first interrupt based on completing the process on the first chunk of data, process one or more second chunks of data without generating an interrupt, receive an acknowledgment of the first interrupt subsequent to processing the one or more second chunks of data, process a third chunk of data, and generate a second interrupt based on completing the process on the third chunk of data.

In another example, this disclosure describes a method for interrupt handling, the method comprising processing, by a first processing core, a first chunk of data, generating, by the first processing core, a first interrupt based on completing the process on the first chunk of data, processing, by the first processing core, one or more second chunks of data without generating an interrupt, receiving, by the first processing core, an acknowledgment of the first interrupt subsequent to processing the one or more second chunks of data, processing, by the first processing core, a third chunk of data, and generating, by the first processing core, a second interrupt based on completing the process on the third chunk of data.

In another example, this disclosure describes a non-transitory computer-readable storage medium storing instructions that, when executed, cause one or more processors to process a first chunk of data, generate a first interrupt based on completing the process on the first chunk of data, process one or more second chunks of data without generating an interrupt, receive an acknowledgment of the first interrupt subsequent to processing the one or more second chunks of data, process a third chunk of data, and generate a second interrupt based on completing the process on the third chunk of data.

In another example, this disclosure describes an apparatus for interrupt handling, the apparatus comprising means for processing a first chunk of data, means for generating a first interrupt based on completing processing the first chunk of data, means for processing one or more second chunks of data without generating an interrupt, means for receiving an acknowledgment of the first interrupt subsequent to processing the one or more second chunks of data, means for processing a third chunk of data, and means for generating a second interrupt based on completing the process on the third chunk of data.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example processing system according to one to more aspects of this disclosure.

FIG. 2 is a block diagram showing one example of inter-processor communication according to one to more aspects of this disclosure.

FIG. 3 is another block diagram showing one example of inter-processor communication according to one to more aspects of this disclosure.

FIG. 4 is a flowchart showing one example of interrupt generation according to one to more aspects of this disclosure.

FIG. 5 is a flowchart showing one example of interrupt handling and acknowledgment according to one to more aspects of this disclosure.

FIG. 6 is a conceptual diagram illustrating intra frame interrupt delay according to one to more aspects of this disclosure.

FIG. 7 is a conceptual diagram illustrating inter frame interrupt delay according to one to more aspects of this disclosure.

FIG. 8 is a block diagram illustrating an example of interrupt generation according to one to more aspects of this disclosure.

FIG. 9 is a flowchart showing another example of interrupt generation according to one to more aspects of this disclosure.

FIG. 10 is a flowchart showing another example of interrupt handling and acknowledgment according to one to more aspects of this disclosure.

FIG. 11 is a block diagram illustrating a vehicle in which the processing system of FIG. 1 may be implemented.

### DETAILED DESCRIPTION

Multi-core processing systems, such as a system-on-chip (SOC), may include multiple processing cores of different types in an integrated circuit (e.g., within a single chip). For example, an SOC may include two or more processing cores, each designed with a different architecture or intended for specific types of computations. For example, an SOC might combine a general-purpose central processing unit (CPU) core with specialized cores such as a graphics processing unit (GPU), a digital signal processor (DSP), an image signal processor (ISP), a neural signal processor (NSP), and other types of processing cores.

The processing cores within the SOC may be interconnected through a shared bus or a network-on-chip (NoC) architecture, allowing for communication and data sharing between cores. In some examples, rather than being connected directly with each other, the multiple processing cores may be arranged in a star topology, where communication between the processing cores is handled by a central inter-processor communication controller (IPCC). The SOC may also include shared memory resources, such as cache memory and system memory, to facilitate data exchange and improve overall system performance.

The IPCC may receive an interrupt from a source processing core that indicates that data (e.g., a chunk or subset of the total amount data to be processed) has been processed and is available in memory for a destination processing core. The source processing core may also provide to the IPCC an index or other information that identifies the chunk of data relative to other chunks for data. The IPCC may generate an indication to the destination processing core that the chunk of data is available and may further send an acknowledgment back to the source processing core that the interrupt has been processed.

As the number of source processing cores and destination processing cores increases, the behavior of the IPCC may become unpredictable. Due to the large number of interrupts, the IPCC may need to handle at any given time, the latency and delay time at the IPCC at the time of the interrupts is not predictable. This can cause a problem with timing sensitive applications, such as automotive (e.g., due to safety implications) or XR applications (e.g., to reduce lag when a user's head pose changes).

To reduce the latency across different processing cores, the IPCC is configured to direct routing of data between the processing cores. In one example, the IPCC may be configured to use the bus architecture of the SOC to direct data between cores (e.g., between an ISP and an NSP for image-based tasks). In some examples, the communication of data between the ISP and the NSP may be performed at the frame level. For example, the ISP generates an interrupt when the ISP has finished processing an entire frame of image data. As such, the ISP may be configured to wait until the entire frame is processed and stored in memory before sending an interrupt to the IPCC indicating the data is ready for the destination core (e.g., the NSP).

To reduce the latency further, a source processing core may be configured to send interrupts at finer granularities. For example, an ISP may send an interrupt after processing a slice (e.g., N number of lines) of a frame of image data, rather than waiting for the whole frame to be completed. In this way, the destination processing core may start consuming the data after only a partial amount of a frame has been processed by the ISP and stored to cache/memory, hence reducing the overall latency. However, sending interrupts to the IPCC at finer granularities increases the load on the IPCC, especially for situations where multiple processing cores may be using the IPCC at the same time. As such, bottlenecks at the IPCC may occur. Such a bottleneck may cause the IPCC to fail to send an acknowledgment back to the source processing core that the previous interrupt was processed before the source processing core had completed the next chunk (e.g., slice) of data.

In such a situation, the source processing core may simply pause processing of data, which may be undesirable for time-sensitive applications. In other examples, the IPCC may need to maintain a large buffer (e.g., a FIFO) to store all potential interrupts the IPCC may receive. The buffer may be designed for a worst case latency scenario, but still may not be large enough as more processing core are configured to process the same data. Designing for the worst case scenario is expensive in terms of hardware cost. This problem can be exacerbated in automotive-based applications as the number of camera sensors and other hardware may results in large number of interrupts that may overwhelm the IPCC.

In accordance with the techniques of this disclosure, to avoid system slowdowns or stalls due to a large number of interrupts, source processing cores may be configured to refrain from sending interrupts when an acknowledgment of a previous interrupt has not been received from the IPCC. The source processing core may continue to process subsequent chunks of data and store the chunks of data to memory, but will not send further interrupts. When an acknowledgment of a previous interrupt has been received from the IPCC, the source processing core will resume sending an interrupt for the most recent chunk of data that has been processed.

As such, consecutive interrupts received by the IPCC may not be for continuous chunks of data. The IPCC may determine that the next interrupt received by the IPCC is not for a continuous chunk of data. In that case, the IPCC may indicate to the destination processing core that multiple chunks of data are now available for processing. By refraining from sending interrupts when the acknowledgment of the previous interrupt is not received, the techniques of this disclosure may avoid overloading the IPCC with interrupts. Also, by continuing to process data while refraining from sending the interrupts, the source processing device may prevent any delays for time sensitive use cases.

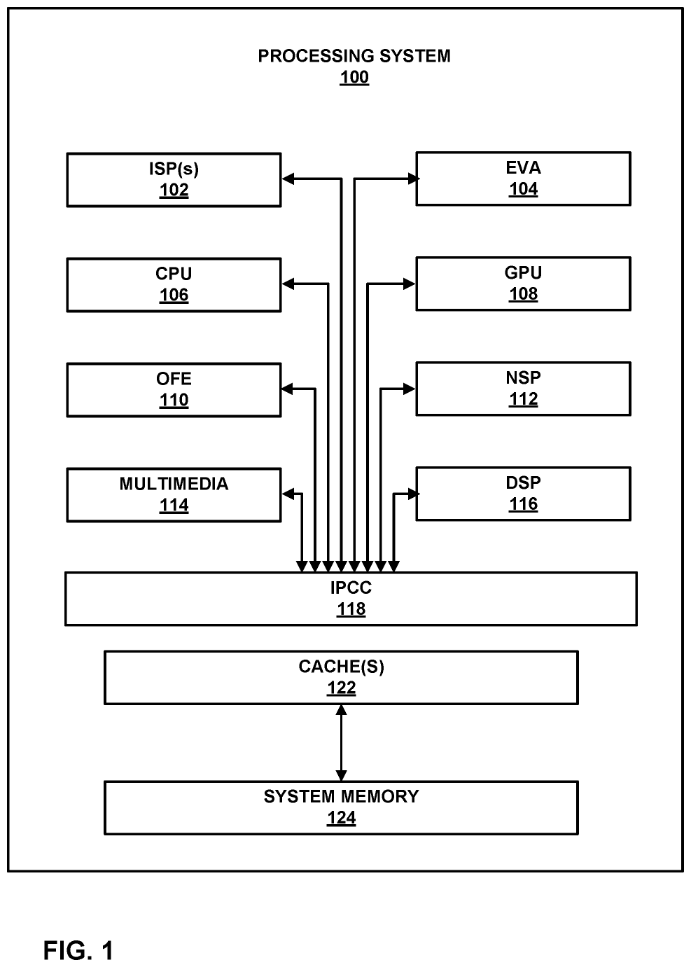

FIG. 1 is a block diagram illustrating an example processing system 100 according to one to more aspects of this disclosure. Processing system 100 may be a multi-core processing system, such as an SOC, and may be used in any number of applications. For example, processing system 100 may be used in autonomous driving applications, advanced driver assistance systems (ADAS), virtual reality (VR) systems, extended reality (XR) systems, mobile phones, and/or other embedded systems. Processing system 100 may include multiple processing cores, including an image signal processor(s) (ISPs) 102, engine for visual analytics (EVA) 104, central processing unit (CPU) 106, graphics processing unit (108), offline front end (OFE) 110, neural signal processor (NSP) 112, multimedia processors 114, and digital signal processor 116. Of course, more or fewer processing cores may be included in processing system 100.

CPU 106 may comprise a general-purpose or a special-purpose processor that controls operation of processing system 100. CPU 106 may serve as the primary processing unit within processing system 100. In some examples, CPU 106 may include multiple processing cores, each capable of executing instructions and performing arithmetic and logical operations. CPU 106 may execute the operating system of processing system 100, as well as other software applications. CPU 106 may also be configured to handle tasks such as fetching instructions from memory, decoding them, and executing them to perform computations and control operations. CPU 106 may include various cache levels, registers, and pipeline stages to optimize performance and efficiency. CPU 106 may also be configured to interface with other components within processing system 100, such as memory controllers, peripheral interfaces, and accelerators, to facilitate data exchange and system coordination.

ISP(s) 102 is a specialized processing core responsible for processing and enhancing raw image sensor data to generate high-quality images. In some examples, processing system 100 may include multiple ISPs, particularly for applications where image data from multiple camera sensors may be processed at the same time. The following description is for one ISP 102. One or more of ISP(s) 102 may be configured similarly. In general, ISP(s) 102 may be configured to perform pre-processing of images, image enhancement, and post-processing of images. In some examples, ISP 102 may also be configured to store raw sensor data to memory (e.g., cache(s) 122 and/or system memory 124).

In the pre-processing stage, ISP 102 may be configured to perform various tasks to prepare the raw sensor data for further processing. Such tasks may include demosaicing, where ISP 102 reconstructs full-color images by interpolating missing color information from the sensor's color filter array. Pre-processing may further include sensor-specific corrections, such as compensating for lens distortion, color aberration, or noise. Additionally, ISP 102 may apply techniques like black level calibration, white balance adjustment, auto focus, and/or auto exposure control to ensure accurate and consistent image capture.

Once the sensor data has been pre-processed, ISP 102 may be configured to enhance the visual quality of the image. For example, ISP 102 may use one or more techniques to improve sharpness, contrast, and dynamic range of an image. Such techniques may use edge enhancement algorithms to enhance fine details, tone mapping to optimize image contrast and highlight details, and gamma correction to adjust the overall brightness and tone curve. ISP 102 may also apply noise reduction algorithms to suppress unwanted noise while preserving image details, resulting in cleaner and more visually appealing images.

In the post-processing stage, ISP 102 may perform additional adjustments and prepare the processed image for display or storage. Additional adjustments may include color correction, where ISP 102 improves color representation by applying color matrices or calibrating color response. Additionally, ISP 102 may apply compression algorithms (e.g., image or video compression) to reduce image file size while preserving image quality. Post-processing may also involve tasks like image format conversion, metadata embedding, or applying specific image filters or effects based on user preferences.

OFE 110 is also an ISP and may perform the same tasks as ISP(s) 102. However, rather than operating on image data directly from a camera sensor, OFE 110 may process image data that is stored in memory (e.g., cache(s) 122 and/or system memory 124). For example OFE 110 may perform processing tasks on raw image data and/or processed image data saved to memory by ISP(s) 102.

EVA 104 is a specialized processing core that may be configured to analyze image data to determine features present in the image. EVA 104 may perform techniques such as objection detection, depth detection, image segmentation, pose detection, or other techniques of image data processed by ISP(s) 102, OFE 110, or another processing core of processing system 100.

GPU 108 is a specialized processing core designed to accelerate and handle the processing tasks related to computer graphics and visual rendering. Unlike a CPU, which focuses on general-purpose computing tasks, GPU 108 is specifically optimized for parallel processing and rendering complex graphics in real-time.

The primary function of GPU 108 is to render and display visual elements on a screen. GPU 108 processes and manipulates a large amount of data simultaneously by breaking down complex graphics tasks into smaller, parallel computations. This parallelism allows GPU 108 to perform operations on multiple data elements at once, resulting in faster and more efficient rendering of images, videos, and 3D graphics. GPU 108 may include thousands of smaller processing units called stream processors, which work together to execute computations in parallel. In addition to graphics rendering, GPU 108 may be used in applications beyond gaming and visual effects. GPU 108 may be used for general-purpose computing tasks that can be parallelized, such as machine learning, scientific simulations, cryptocurrency mining, and video encoding.

NSP 112 is a specialized circuit configured for implementing control and arithmetic logic for executing machine learning algorithms, such as algorithms for processing artificial neural networks (ANNs), deep neural networks (DNNs), random forests (RFs), kernel methods, and the like. NSP 112 may sometimes alternatively be referred to as a tensor processing unit (TPU), a neural network processor (NNP), an intelligence processing unit (IPU), or a vision processing unit (VPU).

NSP 112 may be configured to accelerate the performance of common machine learning tasks, such as image classification, machine translation, object detection, and various other tasks. In some examples, a plurality of NSPs 112 may be included in processing system 100, while in other examples NSPs 112 may be part of a dedicated machine learning accelerator device.

Multimedia processor 114 is a specialized processing core designed to handle multimedia data processing tasks efficiently. Multimedia processor 114 may integrate various multimedia-specific functionalities, such as audio decoding, video decoding, and/or image processing, into a single chip or module. The purpose of a multimedia processor is to enable seamless multimedia playback, rendering, and manipulation in devices. Multimedia processor 114 may include dedicated hardware accelerators and specialized instructions that optimize the processing of multimedia data. They can decode and encode various audio and video formats, handle complex graphics rendering for gaming and multimedia applications, and perform image processing operations such as resizing, filtering, and color manipulation.

DSP 116 is a s a specialized processing core designed to efficiently process digital signals in real-time. DSP 116 may be used for executing mathematical and signal processing operations, making it ideal for applications involving audio, video, telecommunications, control systems, and other signal-intensive tasks.

DSP 116 may be optimized for performing computations on discrete-time signals by using specialized hardware features and algorithms. In some examples, DPS 116 may have dedicated arithmetic units, data memory, and instruction sets tailored for efficient signal processing tasks. DSP 116 may be configured to execute complex operations like filtering, Fourier transforms, convolution, modulation/demodulation, and other mathematical operations required to manipulate and analyze digital signals.

Though not shown in FIG. 1, the processing cores within processing system 100 may be interconnected through a shared bus or a network-on-chip (NoC) architecture, allowing for communication and data sharing between cores. Processing system 100 may further include shared memory resources, such as cache(s) 122 and system memory 124, to facilitate data exchange between the processing cores. Each of the processing cores in processing system 100 may be connected to caches(s) 122 and system memory 124. In general, cache(s) 122 may be one or more cache memories that are integrated into the SOC and are quickly accessible by the processing cores. That is, the processing cores of processing system 100 may be configured to write and retrieve data to cache(s) 122 more quickly than to system memory 124.

Cache(s) 122 may include multiple levels of cache memory. For example, cache(s) 122 may include level 1 (L1) caches, level 2 (L2) caches, and level 3 (L3) caches. An L1 cache may be divided into a separate instruction cache (L1I) and data cache (LID) to store frequently used instructions and data. An L2 cache is typically larger than an L1 cache and acts as a middle layer between L1 cache and system memory 124. An L3 cache is typically larger than an L2 cache and may be shared among multiple processing cores. In the examples of this disclosure, data written to cache(s) 122 by one processing core (e.g., a source processing core) to be later consumed by another processing core (e.g., a destination processing core) may be an L3 cache.

System memory 124 may be one or more memory units that are accessible to the processing cores of processing system 100, but at a slower speed than cache(s) 122. System memory 124 may offer a larger amount of storage as compared to cache(s) 122. In one example, system memory 124 may be random-access memory (RAM), such as double data rate (DDR) memory. DDR memory provides a higher data transfer rate compared to its predecessor, synchronous dynamic random-access memory (SDRAM), by transferring data on both the rising and falling edges of a clock signal. This double data rate operation allows for increased data throughput and improved performance.

Each of the aforementioned processing cores of processing system 100 may be configured to process data (e.g., chunks or subsets) of data after such data has been processed by another processing core. In this context, a “chunk” or “subset” of data is an amount of data less than all of the data that is to be processed. In the context of image processing, a chunk of data may be an entire frame of a sequence of frames. In other examples, the chunk of data may be a slice of a frame of a sequence of frames of image data. The slice of the frame may be N number of lines of the frame (e.g., 100 lines, 200 lines, 1000 lines, etc.). While the techniques of this disclosure will be described below with reference to examples of image processing, the techniques of this disclosure are applicable for use with any types of data.

Rather than connecting each of the processing cores directly with each other, as in a mesh topology, the processing cores of processing system 100 may be connected to each other via an inter-processor communication controller (IPCC) 118, arranged in a star topology. In this way, the amount of physical wiring may be decreased and the size of processing system 100 may be reduced. As will be explained in more detail below, IPCC 118 controls data flows between processing cores. In the context of an SOC, the term “star topology” typically refers to the internal bus architecture or interconnect structure within the chip itself. In the star topology of processing system 100, the central hub is represented by IPCC 118. IPCC 118 serves as the central point from which all other components or subsystems within the SOC are connected. Each subsystem or processing core has a dedicated connection to IPCC 118. IPCC 118 communicates with other subsystems and processing cores by sending and receiving data through the interconnect structure.

In general, IPCC 118 may be configured to receive interrupts (or interrupt requests (IRQs)) from a processing core (e.g., a source processing core) of processing system 100. The interrupts may indicate that a particular chunk of data is stored in memory (e.g., cache(s) 112 and/or system memory 124) and is available for processing by another processing core. The interrupts may further include information that specifically identifies the chunk of data that is available. IPCC 118 may then provide an indication to another processing core (e.g., a destination processing core) of processing system 100 indicating that the chunk of data is in memory and is available for processing. IPCC 118 may then send an acknowledgment back to the source processing core indicating that the interrupt has been processed (e.g., the destination processing core has been informed of the available data).

In accordance with the techniques of this disclosure, to avoid system slowdowns or stalls due to a large number of interrupts, source processing cores of processing system 100 may be configured to refrain from sending interrupts when an acknowledgment of a previous interrupt has not been received from IPCC 118. A source processing core is any processing core of processing system 100 that initially processes data before such processed data is subsequently processed by another processing core. In the context of an image processing application, the source processing core may be ISP 102.

The source processing core may continue to process subsequent chunks of data and store the chunks of data to memory, but will not send further interrupts. When an acknowledgment of a previous interrupt has been received from IPCC 118, the source processing core will resume sending an interrupt for the most recent chunk of data that has been processed.

As such, consecutive interrupts received by IPCC 118 may not be for continuous chunks of data. IPCC 118 may determine that the next interrupt received is not for a continuous chunk of data. In that case, IPCC 118 may indicate to a destination processing core of processing system 100 that multiple chunks of data are now available for processing. The destination processing core is any processing core that is configured to process data after having first been processed by the source processing core. By refraining from sending interrupts when the acknowledgment of the previous interrupt is not received, the techniques of this disclosure may avoid overloading IPCC 118 with interrupts. Also, by continuing to process data while refraining from sending the interrupts, the source processing device may prevent any delays for time sensitive use cases.

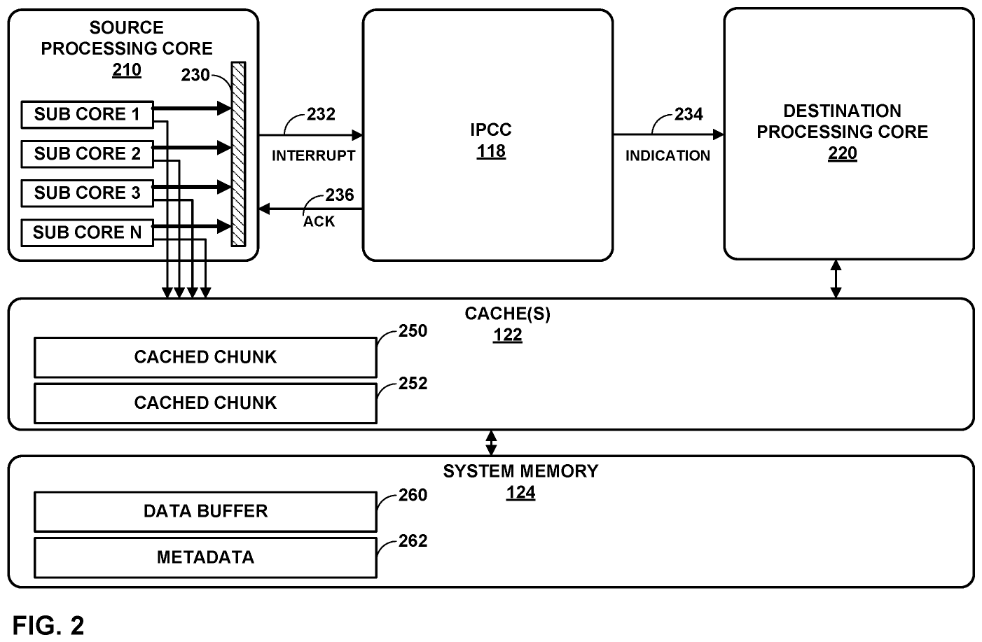

Additional details of the techniques of this disclosure are described below with reference to FIGS. 2-10. Note that any of the techniques described below with reference to a processing core and/or IPCC 118 may be performed by any combination of software, firmware, and/or dedicated hardware executed by the processing core and/or IPCC 118. For example, any combination of techniques of this disclosure may be performed by software drivers and/or software applications executed by a processing core and/or IPCC 118.

FIG. 2 is a block diagram showing one example of inter-processor communication according to one to more aspects of this disclosure. As shown in FIG. 2, source processing core 210 may be configured to process chunks of data. Source processing core 210 may be any processing core of processing system 100. In some examples, source processing core may include multiple sub cores (e.g., sub core 1, sub core 2, sub core 3, sub core N). Each of the sub cores of source processing core 210 may individually process chunks of data, store the chunks of data to memory, and generate interrupts in accordance with the techniques of this disclosure. For example, when source processing core 210 is an ISP 102, each of the sub cores may be configured to perform a different operation on an image received from a camera sensor. Some sub cores may perform one or more pre-processing or post-processing steps described above, while other sub cores may process and store raw sensor data.

As described above, source processing core 210 may be configured to operate on chunks or subsets of data, and to generate interrupts based on the completion of processing of such chunks of data. As shown in FIG. 2, source processing core 210 may store cached chunk 250 and cached chunk 252 in cache(s) 122 after completion of processing each hunk. Additionally, after completion of processing a chunk, interrupt generator 230 of source processing core 210 may generate interrupt 232 to send to IPCC 118.

In general, interrupt 232 indicates to IPCC 118 that a chunk of data has been processed and is stored in cache(s) 122 for use by destination processing core 220. In addition, interrupt generator 230 may generate an indication or other information that specifically identifies the cached chunk. That is, the indication specifically identifies a stored chunk and differentiates it from other chunks that are stored or will be stored. In the context of image data, the indication may identify the specific frame the data comes from as well as the slice number or ID (e.g., a specific N number of lines of the frame). In some examples, interrupt generator 230 may store the indication of the specific chunk in a table in a memory (e.g., an interrupt memory) that is accessible by IPCC 118.

In response to interrupt 232, IPCC 118 may send indication 234 to destination processing core 220 indicating that the cached chunk related to interrupt 232 is stored in memory (e.g., cache(s) 222 or system memory 124), and is available to destination processing core 220 for further processing. After sending indication 234 to destination processing core 220, IPCC 118 may send acknowledgement (ack) 236 to source processing core 210 indicating that the interrupt 232 has been processed.

The example of FIG. 2 shows source processing core 210 storing cached chunks 250 and 252 in cache(s) 122. In other examples, source processing core 210 may store chunks of data into system memory 124. For example, if cache(s) 122 are full or if quality of service metrics are not being met, cached chunks may be moved to system memory 124. As will be explained in more detail below, in examples where source processing core 210 skips sending interrupts for a number of chunks because an acknowledgment has not been received from IPCC 118, processing system 100 may move cached chunks from cache(s) 122 to system memory 124.

System memory 124 may include data buffer 260 (e.g., a frame buffer for image processing applications) that is configured to store data produced by source processing core 210 and/or destination processing core 220. System memory 124 may further include metadata buffer 262 that may include other information concerning the data being processed. For example, for image processing applications, metadata buffer 262 may include information such as per-frame gain, exposure, etc. Destination processing core 220 may reference metadata buffer 262 for certain application when responding to indication 234 related to particular chunks (e.g., as indicated by a slice ID).

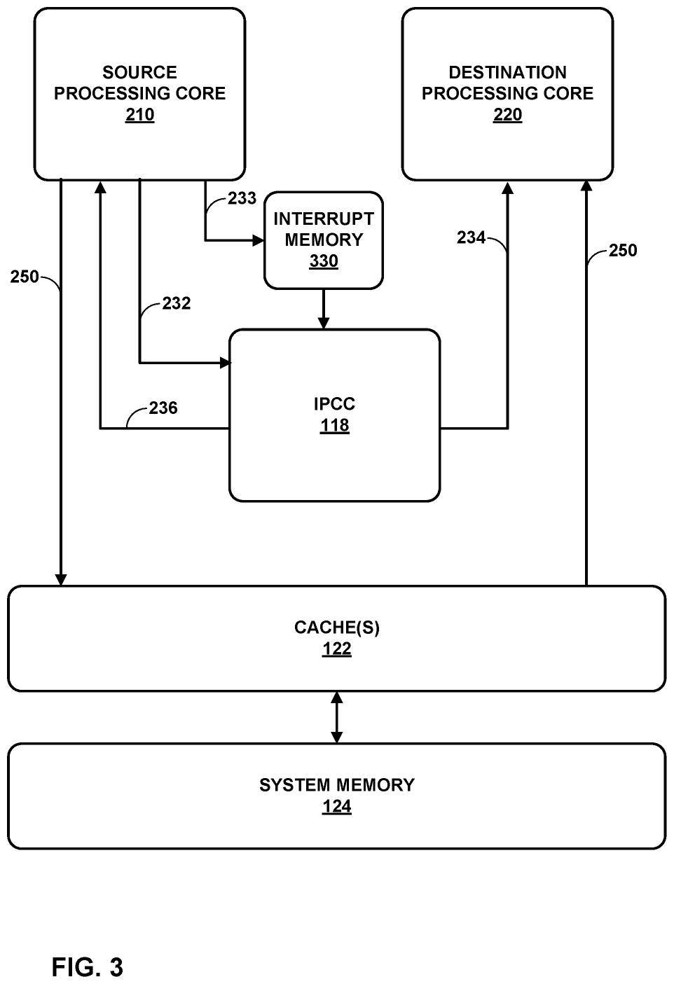

FIG. 3 is another block diagram showing one example of inter-processor communication according to one to more aspects of this disclosure. FIG. 3 shows an example where source processing core 210 processes chunk 250 and stores chunk 250 in cache(s) 122. Source processing core 210 then sends interrupt 232 to IPCC 118. In addition, source processing core 210 send indication 233 to interrupt memory 330. The indication 233 may be stored in a table in interrupt memory 330. In this context, indication 233 is an identification (ID) of chunk 250. That is, indication 233 identifies a particular chunk 250 relative to other chunks of data that have already been processed and are yet to be processed. As will be explained in more detail below, IPCC 118 may use indication 233 stored in interrupt memory 330 to determine which chunks of data have been processed by source processing core 210 and stored to one of cache(s) 122 and system memory 124 in a situation where source processing core 210 skips sending interrupts for some period of time. In the context of image processing, indication 233 may include information that identifies the frame the chunk is from as well as the slice ID of the chunk (i.e., which slice of the frame the chunk represents).

In response to interrupt 232, IPCC 118 may access interrupt memory 330 and provide indication 234 to destination processing core 220. Indication 234 include information about chunk 250 that is available in cache(s) 122 and/or system memory 124 for processing by destination processing core 220. In some examples, indication 234 may indicate a particular line or lines in a table in interrupt memory 330 that includes the information (e.g., IDs) specifying the particular chunks of data that are available. Destination processing core 220 may access chunk 250 from cache(s) 122 and/or system memory 124 and may perform further processing on chunk 250. IPCC 118 may send acknowledgement 236 back to source processing core 210 indicating the interrupt 232 has been processed.

In accordance with the techniques of this disclosure, as described above, to avoid system slowdowns or stalls due to a large number of interrupts, source processing core 210 may be configured to refrain from sending interrupts when acknowledgment of a previous interrupt (e.g., acknowledgement 236) has not been received from IPCC 118. Source processing core 210 may continue to process subsequent chunks of data and store the chunks of data to memory, but will not send further interrupts to IPCC 118. When an acknowledgment of a previous interrupt (e.g., acknowledgment 236) has been received from IPCC 118, source processing core 210 will resume sending an interrupt for the most recent chunk of data that has been processed.

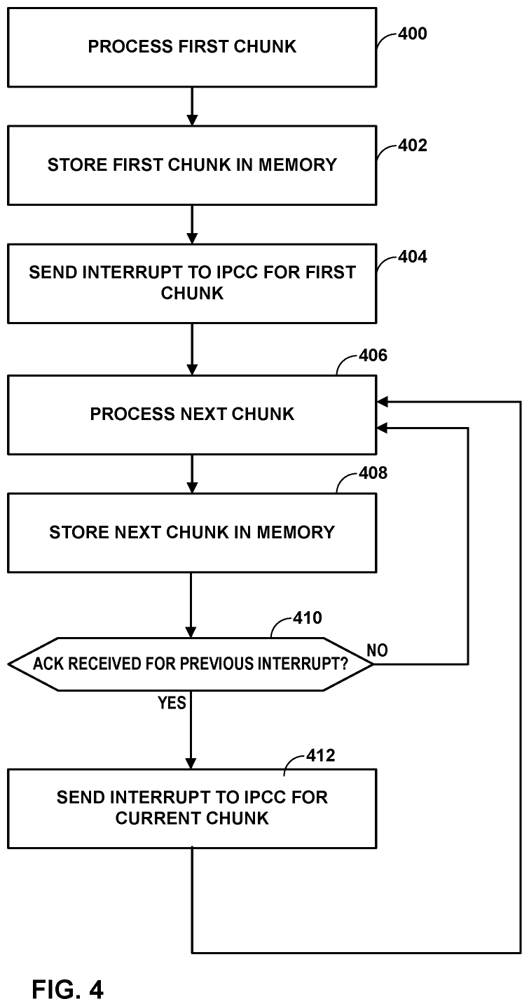

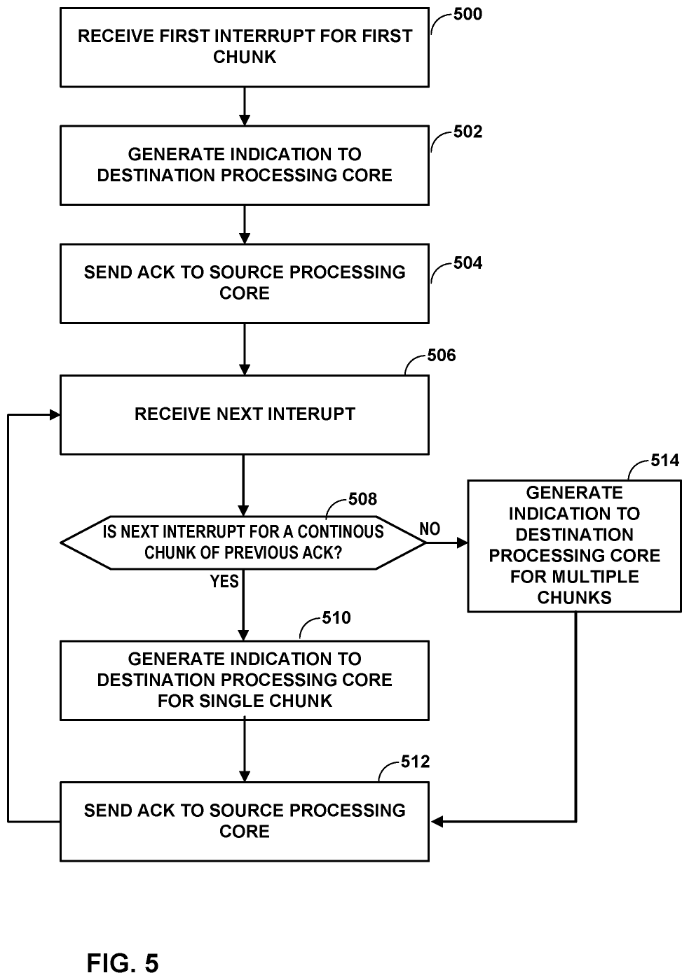

As such, consecutive interrupts received by IPCC 118 may not be for continuous chunks of data. IPCC 118 may determine that the next interrupt received is not for a continuous chunk of data relative to the previous interrupt. In that case, IPCC 118 may indicate to destination processing core 220 that multiple chunks of data are now available for processing. By refraining from sending interrupts when the acknowledgment of the previous interrupt is not received, the techniques of this disclosure may avoid overloading IPCC 118 with interrupts. Also, by continuing to process data while refraining from sending the interrupts, source processing core 210 may prevent any delays for time sensitive use cases. Flowcharts showing example processes for interrupt generation (e.g., by a source processing core) and interrupt handling (e.g., by IPCC 118) are described below with reference to FIG. 4 and FIG. 5.

FIG. 4 is a flowchart showing one example of interrupt generation according to one to more aspects of this disclosure. In general, the techniques of FIG. 4 may be performed by any processing core of processing system 100 acting as a source processing core, including by software executing on any of the processing cores. For case of understanding FIG. 4 will be described with reference to source processing core 210 of FIG. 3.

Source processing core 210 may be configured to process a first chunk of data (400). In one example, the first chunk of data may be a first slice of an image of data. Source processing core 210 may store the first chunk in memory after processing the chunk (410). In the example of FIG. 4, the memory may be cache(s) 122 or system memory 124 if cache(s) 122 are full. After processing and storing the first chunk, source processing core 210 may send an interrupt to IPCC 118 for the first chunk (404).

Source processing core 210 may then continue to process the next chunk of data (406) and store the next chunk of data in memory (408). At 410, source processing core then determines if an acknowledgement (ack) has been received for the previously sent interrupt (e.g., the interrupt for the first chunk). If yes at 410, source processing core 210 then proceeds to send an interrupt to IPCC 412 for the current chunk (i.e., the chunk processed at stored at 406 and 408). If no at 410, source processing core 210 skips sending an interrupt at 412, but instead proceeds to process the next chunk at 406. As shown in FIG. 4, source processing core 210 is configured to continue skipping sending interrupts until an acknowledgement is received for the previously sent interrupt.

FIG. 5 is a flowchart showing one example of interrupt handling and acknowledgment according to one to more aspects of this disclosure. In general, the techniques of FIG. 5 may be performed by IPCC 118, including by software executing on any of the processing cores. FIG. 5 shows the processing of handling interrupts by IPCC 118 generated by source processing core 210 described above in FIG. 4.

IPCC 118 may receive a first interrupt for a first chunk of data from a source processing core (500). In response, IPCC 118 may generate an indication to a destination processing core indicating that the first chunk of data is stored in memory and available for processing (502). IPCC 118 may then send an acknowledgement (ACK) to the source processing core (504). As described above, the timing of sending the ACK may not align with source processing core processing a next chunk of data. That is, in some examples, IPCC 118 may experience delays in processing interrupts and may not send ACKs back to a source processing core before the source processing core has completed processing the next chunk of data. In such circumstances, as described above with reference to FIG. 4, the source processing core may refrain from sending interrupts for subsequently processed chunks until an ACK is received from IPCC 118 for the previously sent interrupt.

Accordingly, when IPCC 118 receives the next interrupt (506), IPCC 118 is configured to determine how many chunks of data have been processed between the last two interrupts. For example, IPCC 118 may determine if the next interrupt (e.g., the interrupt received at 506) is for a continuous chunk of data relative to the previous sent ACK at 504. Because the source processing core provides information in interrupt memory that specifies the particular chunk relative to other chunks, IPCC 118 may access the table in interrupt memory and determine if the chunk identified by the most recently received interrupt (at 506) is for a chunk of data that is continuous with the chunk of data identified by the previous interrupt (at 500).

If yes at 508, IPCC 118 generates an indication to the destination processing core for a single chunk of data (510). IPCC 118 may then send an ACK to the source processing core (512). If no at 508, IPCC 118 generates an indication to the destination processing core for multiple chunks of data (514). IPCC 118 may then send an ACK to the source processing core (512).

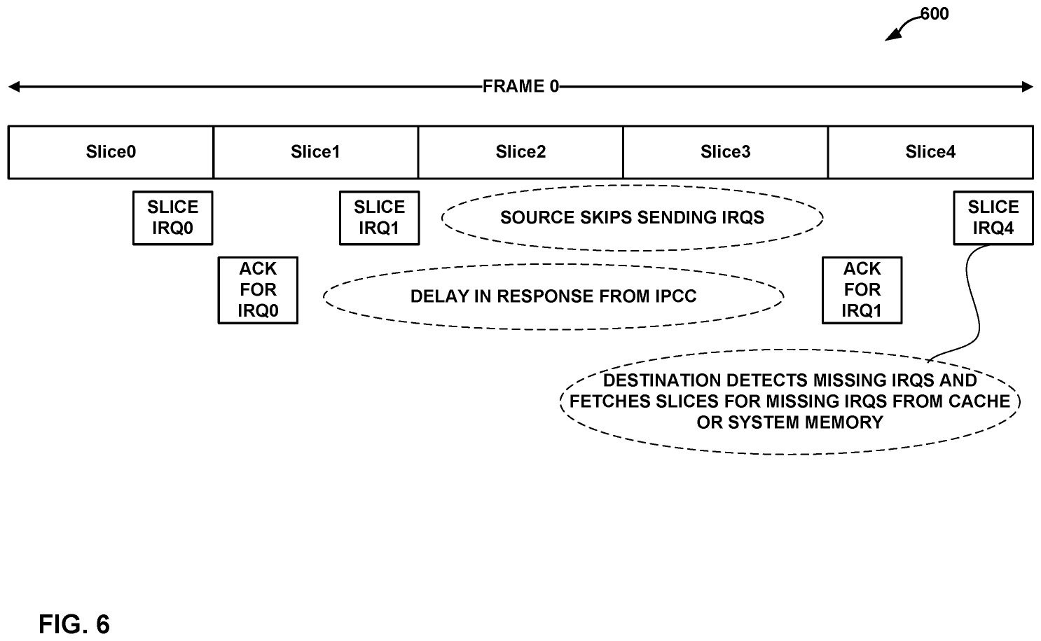

FIG. 6 is a conceptual diagram illustrating intra frame interrupt delay according to one to more aspects of this disclosure. In particular, FIG. 6 shows a scenario 600 where a source processing core, such as ISP 102 of FIG. 1, skips sending interrupts for one or more slices during the processing of a frame. FIG. 6 shows the processing of slices in frame 0. ISP 102 may process slice0 and send an interrupt (slice IRQ0) to IPCC 118. Before finishing processing slice1, ISP 102 receive an ACK (ACK for IRQ0) back from IPCC 118. As such, once ISP 102 finishes processing slice1, ISP 102 may send an interrupt (slice IRQ1) for slice1.

ISP 102 then proceeds to process slice2. However, ISP 102 does not receive any ACK for slice IRQ1 before slice2 has been finished processing. That is, there is delay in response from IPCC 118. Accordingly, ISP 102 (e.g., the source processing core) may skip sending interrupts (IRQS) until the next ACK is received. However, ISP 102 continues to process and store slice1, slice2, and slice3.

In FIG. 6, the next ACK is received sometime during the processing of slice4. In this case, the ACK is for interrupt for slice 1 (ACK for IRQ1). ISP 102 may then resume sending interrupts. As shown in FIG. 6, the next interrupt sent is not for slice2 or slice3, but is an interrupt (slice IRQ4) for slice4. IPCC 118 and/or a destination processing core may detecting missing IRQs based on the information indicating slice4 (e.g., the slice of the next interrupt) not being continuous with the slice of the previously received interrupt (slice1). As such, the destination processing core may be configured to fetch and process slice1, slice2, slice3, and slice4. The destination processing core may fetch the slices from either cache or system memory.

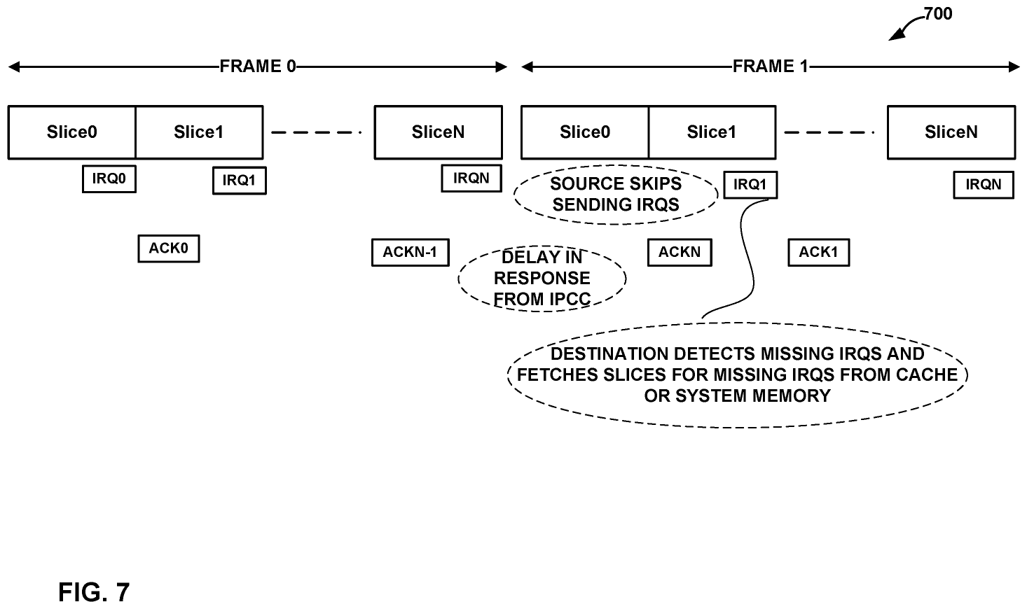

FIG. 7 is a conceptual diagram illustrating inter frame interrupt delay according to one to more aspects of this disclosure. FIG. 7 shows a scenario 700 that is similar to that of scenario 600 in FIG. 6. However, in FIG. 7, the delay in sending interrupts (IRQs) occurs between frames of image data (e.g., between frame 0 and frame 1) rather than in the middle of a frame. However, because ISP 102 may identify both the frame and the slice related to an interrupt, the destination processing core may still detect all of the slices related to the skipped interrupts, even if such slices are in two different frames.

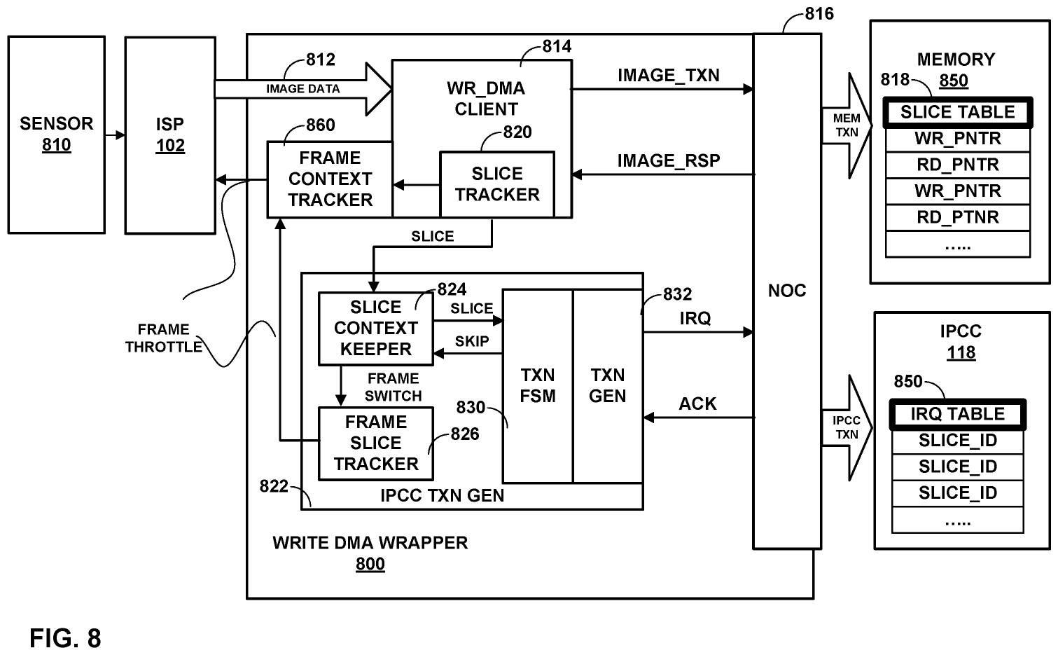

FIG. 8 is a block diagram illustrating an example of interrupt generation according to one to more aspects of this disclosure. In particular, FIG. 8 shows one example of interrupt generation and memory transactions of FIG. 2 in more detail. In the example of FIG. 8, interrupt generation and memory transactions are implemented in software as write direct memory access (DMA) wrapper 800. Write DMA wrapper 800 a wrapper around an individual write DMA (e.g., an individual write of data into memory. DMA is technique used to transfer data directly between processing cores and memory without involving the CPU for every data transfer. DMA allows processing cores to access system memory independently and transfer data in chunks. In general, a wrapper is a software component or code that provides a layer of abstraction or an interface around an existing functionality, system, or resource (in this case write DMA).

Sensor 810 is a camera sensor that is configured to capture still images and/or video data and send frames of image data to ISP 102. ISP 102 may process the frames and send image data 812 (e.g., a slice of image data) to write DMA (WR_DMA) client 814. WR_DMA client 814 writes image data 812 to memory 850 through a transaction (Image_TXN) through NOC 816 (MEM TXN). Once image data 812 is written to memory 814, WR_DMA client 814 receives a response (Image_RSP) from memory 850 through NOC 816. Memory 850 may be any combination of cache(s) 122 and/or system memory 124 of FIG. 1. Memory 850 may store slice table 818 that includes both a write pointer (WR_PNTR) and a read point (RD_PNTR) for each slice stored in memory 850.

Read and write pointers are variables or memory addresses used in computer systems to keep track of the current position or location for reading or writing data within a buffer or data structure. They are commonly used in scenarios where multiple entities or processes need to access shared data concurrently. A read pointer indicates the current position or index from where data is being read from a buffer or data structure. The read pointer represents the location of the next element to be read. As data is read, the read pointer is incremented to move to the next available data element. A write pointer, on the other hand, represents the current position or index for writing data into a buffer or data structure. The writer pointer indicates where the next element should be written. As data is written, the write pointer is incremented to move to the next available position for data storage.

Slice tracker 820 of WR_DMA client 814 tracks the responses (IMAGE_RSP) received that indicate if a slice of the image is written to memory 850. After each slice is written, slice tracker 820 updates IPCC transaction generator 822. Slice tracker 820 also indicates that the frame transmission is complete to frame context tracker 860. Frame context tracker 860 keeps track of the IPCC responses for the whole frame. In one example, if the responses are not received for more than two frames, frame context tracker 860 will throttle ISP 102.

IPCC transaction (TXN) generator (GEN) 822 generates slice and IPCC transactions to memory (e.g., IRQ Table 850) and IPCC 118. IPCC transaction generator 822 includes slice context keeper 824 and frame slice tracker 826. Slice context keeper 824 keeps track of the latest slice from the client and handles the skip of a slice within the frame if the latency for response is greater than the slice time. In this context, the skipping of a slice may be the skipping of sending an IRQ. Frame slice tracker 826 tracks the latest slice from the client when client has moved on to the next frame and a slice for the previous frame is pending. In this context, a client is one stream of image data from ISP 102. Each ISP stream may be associated with one WR_DMA client.

Transaction (TXN) finite state machine (FSM) 830 and TXN generator (GEN) 832 generate memory transactions to write the slice value (WR_PNTR) followed by an interrupt (IRQ) to IPCC 118. TXN FSM 830 indicates the completion of slice to slice context keeper 8224 and frame slice tracker 826. TXN FSM 830 and TXN GEN 832 may receive an ACK back from IPCC 118.

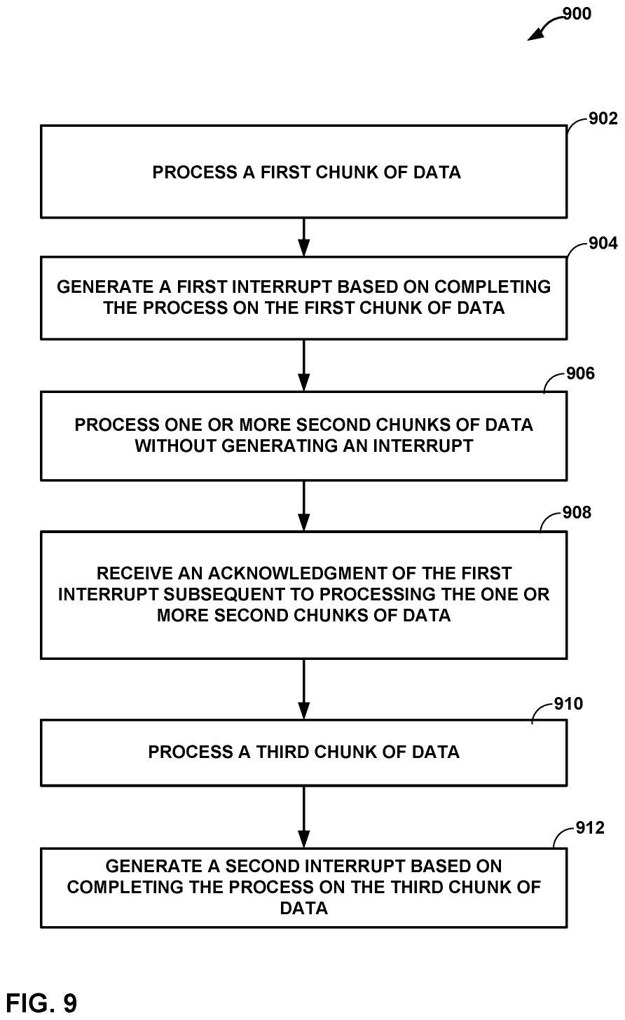

FIG. 9 is a flowchart showing another example of interrupt generation according to one to more aspects of this disclosure. The techniques of FIG. 9 are described with reference to any processing core of processing system 100 of FIG. 1 that may be the source processing core for a particular application. For example, for image processing applications, the source processing core may be ISP(s) 102.

In the example of FIG. 9, to perform process 900, a first processing core (e.g., a source processing core) of processing system 100 may be configured to process a first chunk of data (902). In one example, the first processing core of processing system 100 may be ISP(s) 102 and the first chunk of data may comprise N (e.g., where N is a positive integer) number of lines of pixel data of an image. In some examples, the first processing core of processing system 100 may store the first chunk of data in the one or more cache memories (e.g., cache(s) 122 of FIG. 1) after completing processing of the first chunk of data.

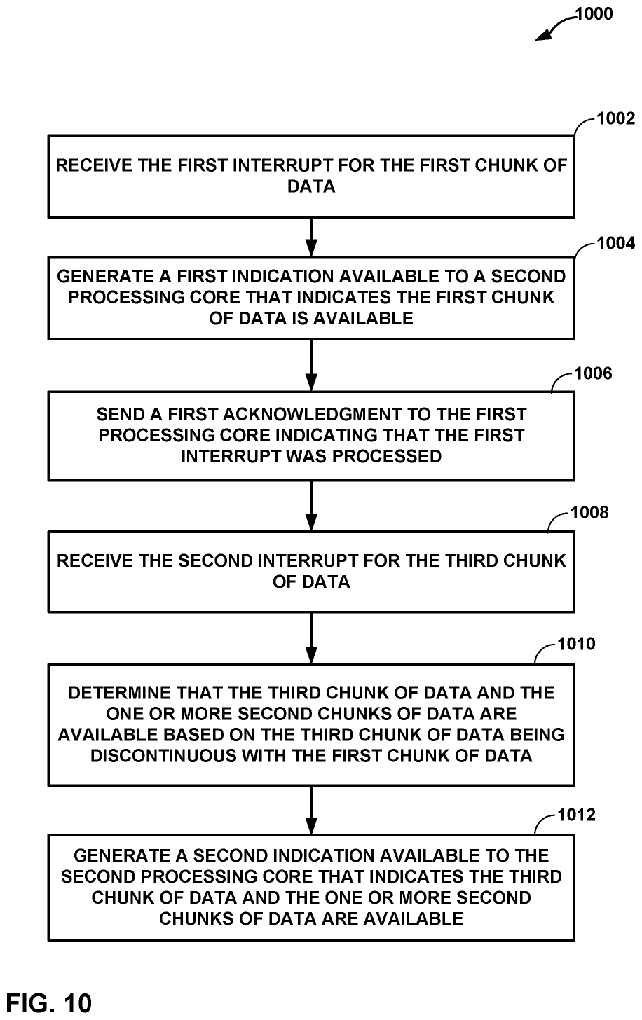

The first processing core of processing system 100 may further be configured to generate a first interrupt based on completing the process on the first chunk of data (904). The first interrupt may be made available to IPCC 118 of FIG. 1. For example, the first processing core of processing system 100 may store a first identification related to the first interrupt in the interrupt memory, wherein the first identification identifies the first chunk of data. In some examples, the first processing core of processing system 100 may store the first identification in a table in the interrupt memory. As will be explained in the description of FIG. 10, IPCC 118 may then indicate to a second processing core (e.g., a destination processing core) of processing system 100 that the first chunk of data is available for processing by the second processing core.

The first processing core of processing system 100 may further be configured to process one or more second chunks of data without generating an interrupt (906). In particular, the first processing core may not generate the interrupt for the one or more second chunks of data based on not receiving an acknowledgement of the first interrupt for the first chunk of data. The lack of acknowledgment indicates that IPCC 118 may be overloaded. As such, the first processing core is configured to suspend the generation of interrupts until an acknowledgment is received. However, the first processing core continues to process chunks of data. After processing the one or more second chunks of data, the first processing core may store the one or more second chunks of data in the one or more cache memories (e.g., cache(s) 122) or in the one or more system memories (e.g., system memory 124) based on a storage availability of the one or more cache memories

Subsequently to processing the one or more second chunks of data, the first processing core of processing system 100 may receive an acknowledgment of the first interrupt subsequent to processing the one or more second chunks of data (908). The first processing core of processing system 100 may then continue to process a third chunk of data (910), and generate a second interrupt based on completing the process on the third chunk of data (912). The second interrupt indicates that the third chunk of data has been processed and is available for a second processing core (e.g., a destination processing core) of processing system 100. For example, the first processing core may store a second identification related to the second interrupt in the interrupt memory, wherein the second identification identifies the third chunk of data. As will be explained in the description of FIG. 10, IPCC 118 may then indicate to a second processing core (e.g., a destination processing core) of processing system 100 that the one or more second chunks of data and the third chunk of data are available for processing by the second processing core.

FIG. 10 is a flowchart showing another example of interrupt handling and acknowledgment according to one to more aspects of this disclosure. The techniques of FIG. 9 are described with reference IPCC 118 and a second processing core of processing system 100 of FIG. 1. The second processing core may be the destination processing core for a particular application. For example, for image processing applications, the destination processing core may be OFE 110, EVA 104, NSP 112, DSP 116, or any other processing core.

The techniques of FIG. 10 below are described as being used in conjunction with the interrupt generation techniques described above with reference to FIG. 9. As such, any discussion of chunks of data and/or interrupts below are the same interrupts and chunks of data described above with reference to FIG. 9.

In the example of FIG. 10, to perform process 1000, IPCC 118 may be configured to receive the first interrupt for the first chunk of data (1002). IPCC 118 may then generate a first indication available to a second processing core that indicates the first chunk of data is available (1004). The second processing core is configured to process the first chunk of data based on the first indication. The second processing core may be configured to access the first chunk of data from the one or more cache memories (e.g., cache(s) 122 of FIG. 1) based on the first indication that indicates the first chunk of data is available.

IPCC 118 may further be configured to send a first acknowledgment to the first processing core indicating that the first interrupt was processed (1006). Processing the interrupt may include providing the indication to the second processing core. As discussed above, in some examples, IPCC 118 may be delayed in sending the first acknowledgement to the first processing core, particularly for applications and use cases where IPCC 118 may be handling interrupts from many different processing cores in a relatively short time frame.

IPCC 118 may be further configured to receive the second interrupt for the third chunk of data (1008). IPCC 118 may determine that the third chunk of data and the one or more second chunks of data are available based on the third chunk of data being discontinuous with the first chunk of data (1010). Because the interrupts sent by the first processing core include information (e.g., the first and second indications described above) that indicates the specific chunks of data, IPCC 118 can determine that consecutive interrupts received from the first processing core are not for continuous chunks of data. IPCC 118 may determine that any intervening chunks of data (e.g., the one or more second chunks of data described above) are also available for processing by the second processing core. IPCC 118 may access the first identification identifying the first chunk related to the first interrupt from an interrupt memory. Likewise, IPCC 118 may access the second identification from the interrupt memory based on the second interrupt.

IPCC 118 may then generate a second indication available to the second processing core that indicates the third chunk of data and the one or more second chunks of data are available (1012). IPCC 118 may also send a second acknowledgment to the first processing core indicating that the second interrupt was processed. The second processing unit may process the one or more second chunks of data and the third chunk of data based on the second indication. The second processing unit may access the one or more second chunks of data and the third chunk of data based on the second indication from the one or more cache memories (e.g., cache(s) 122 of FIG. 1) or from the one or more system memories (e.g., system memory 124 of FIG. 1).

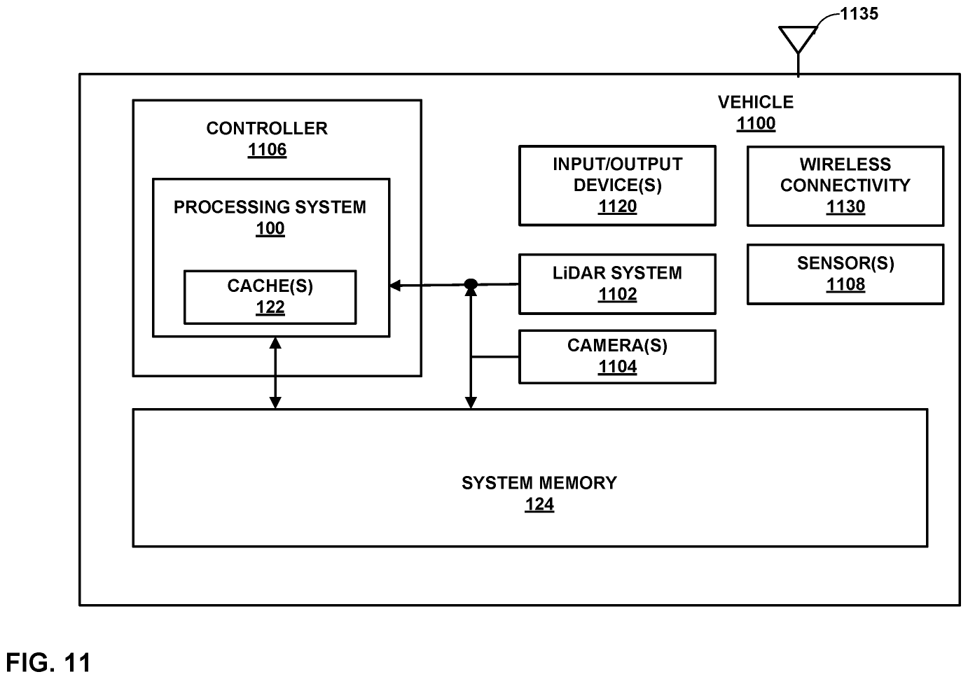

FIG. 11 is a block diagram illustrating a vehicle in which the processing system 100 of FIG. 1 may be implemented. Processing system 100 of FIG. 1 may be used in a vehicle 1100, such as an autonomous driving vehicle or an assisted driving vehicle (e.g., a vehicle having an advanced driver-assistance systems (ADAS) or an “ego vehicle”). In such an example, processing system 100 may represent a component of an ADAS. In other examples, processing system 100 may be used in other applications.

Vehicle 1100 may include LiDAR system 1102, camera(s) 1104, controller 1106, one or more sensor(s) 1108, input/output device(s) 1120, wireless connectivity component 1130, and system memory 124. LiDAR system 1102 may include one or more light emitters (e.g., lasers) and one or more light sensors. LiDAR system 1102 may be deployed in or about a vehicle. For example, LiDAR system 1102 may be mounted on a roof of a vehicle, in bumpers of a vehicle, and/or in other locations of a vehicle. LiDAR system 1102 may be configured to emit light pulses and sense the light pulses reflected off of objects in the environment. LiDAR system 1102 may emit such pulses in a 360 degree field around so as to detect objects within the 360 degree field, such as objects in front of, behind, or beside a vehicle. While described herein as including LiDAR system 1102, it should be understood that another distance or depth sensing system may be used in place of LiDAR system 1102. The output of LiDAR system 102 are called point clouds or point cloud frames.

Camera(s) 1104 may be any type of camera configured to capture video or image data in the environment around vehicle 1100. For example, camera(s) 1104 may include a front facing camera (e.g., a front bumper camera, a front windshield camera, and/or a dashcam), a back facing camera (e.g., a backup camera), side facing cameras (e.g., cameras mounted in sideview mirrors). Camera(s) 1104 may be a color camera or a grayscale camera. In some examples, camera(s) 1104 may be a camera system including more than one camera sensor. In some examples, vehicle 1100 may include multiple camera(s) 1104 and processing system 100 may include multiple ISP(s) 102 (see FIG. 1). In some examples, processing system 100 may have an ISP 102 for each of camera(s) 1104. In other examples, while still having multiple ISP(s) 102, each ISP of ISP(s) 102 may be configured to process image data from multiple cameras of camera(s) 1104.

Wireless connectivity component 1130 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity component 1130 is further connected to one or more antennas 1135.

Vehicle 1100 may also include one or more input and/or output devices 1120, such as screens, touch-sensitive surfaces (including touch-sensitive displays), physical buttons, speakers, microphones, and the like. Input/output device(s) 120 (e.g., which may include an I/O controller) may manage input and output signals for vehicle 1100. In some cases, input/output device(s) 1120 may represent a physical connection or port to an external peripheral. In some cases, input/output device(s) 1120 may utilize an operating system. In other cases, input/output device(s) 1120 may represent or interact with a modem, a keyboard, a mouse, a touchscreen, or a similar device. In some cases, input/output device(s) 1120 may be implemented as part of a processor processing system 100. In some cases, a user may interact with a device via input/output device(s) 1120 or via hardware components controlled by input/output device(s) 1120.

Controller 1106 may be an autonomous or assisted driving controller (e.g., an ADAS) configured to control operation of vehicle 1100 (e.g., including the operation of a vehicle). For example, controller 1106 may control acceleration, braking, and/or navigation of vehicle through the environment surrounding vehicle. Controller 1106 may include one or more processors in processing system 100. Processing system 100, as shown in FIG. 1, may include multiple processing cores as well as an IPCC. The multiple processing cores and the IPCC may be configured to perform any combination of the interrupt generation and interrupt handling techniques of this disclosure.

Vehicle 1100 may also include one or more sensor processing units associated with LiDAR system 1102, camera(s) 1104, and/or sensor(s) 1108. Processor system 100 may include one or more processing cores associated with camera 104 and/or sensor(s) 108, and/or a navigation processor associated with sensor(s) 108, which may include satellite-based positioning system components (e.g., GPS or GLONASS) as well as inertial positioning system components. In some aspects, sensor(s) 108 may include direct depth sensing sensors, which may function to determine a depth of or distance to objects within the environment surrounding vehicle 1100.

Vehicle 1100 may also include cache(s) 122 and system memory 124 as described above with reference to FIG. 1, as well as other types of memory. Other types of memory may include RAM, read-only memory (ROM), or a hard disk. In some examples, system memory 124 or other memory of vehicle 1100 and/or processing system 100 is used to store computer-executable software including instructions that, when executed, cause a processor to perform various functions described herein. In some cases, vehicle 1100 may include memory that stores, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

Examples of the various aspects of this disclosure may be used individually or in any combination. Additional aspects of the disclosure are detailed in numbered clauses below.

Clause 1. An apparatus for interrupt handling, the apparatus comprising: one or more memories; and a first processing core coupled to the one or more memories, the first processing core configured to: process a first chunk of data; generate a first interrupt based on completing the process on the first chunk of data; process one or more second chunks of data without generating an interrupt; receive an acknowledgment of the first interrupt subsequent to processing the one or more second chunks of data; process a third chunk of data; and generate a second interrupt based on completing the process on the third chunk of data.

Clause 2. The apparatus of Clause 1, further comprising: an inter-processor communication controller configured to: receive the first interrupt for the first chunk of data; generate a first indication available to a second processing core that indicates the first chunk of data is available; send a first acknowledgment to the first processing core indicating that the first interrupt was processed; receive the second interrupt for the third chunk of data; determine that the third chunk of data and the one or more second chunks of data are available based on the third chunk of data being discontinuous with the first chunk of data; and generate a second indication available to the second processing core that indicates the third chunk of data and the one or more second chunks of data are available.

Clause 3. The apparatus of Clause 2, wherein the inter-processor communication controller is further configured to: send a second acknowledgment to the first processing core indicating that the second interrupt was processed.

Clause 4. The apparatus of Clause 2, further comprising: the second processing core, wherein the second processing core is configured to: process the first chunk of data based on the first indication; and process the one or more second chunks of data and the third chunk of data based on the second indication.

Clause 5. The apparatus of Clause 4, further comprising: an interrupt memory; wherein the first processing core is configured to store a first identification related to the first interrupt in the interrupt memory, wherein the first identification identifies the first chunk of data, and store a second identification related to the second interrupt in the interrupt memory, wherein the second identification identifies the third chunk of data, and wherein the inter-processor communication controller is configured to access the first identification from the interrupt memory based on the first interrupt, and access the second identification from the interrupt memory based on the second interrupt.

Clause 6. The apparatus of Clause 5, wherein the first processing core is configured to store the first identification and the second identification in a table in the interrupt memory.

Clause 7. The apparatus of Clause 5, further comprising: one or more cache memories, wherein the first processing core is configured to store the first chunk of data in the one or more cache memories after completing processing of the first chunk of data, and wherein the second processing core is configured to access the first chunk of data from the one or more cache memories based on the first indication that indicates the first chunk of data is available.

Clause 8. The apparatus of Clause 7, further comprising: one or more system memories, wherein the first processing core is configured to store the one or more second chunks of data in the one or more cache memories or in the one or more system memories based on a storage availability of the one or more cache memories.

Clause 9. The apparatus of Clause 8, wherein the first processing core, the second processing core, the inter-processor communication controller, the interrupt memory, the one or more cache memories, and the one or more system memories are part of a system-on-chip (SOC) integrated circuit.

Clause 10. the apparatus of Clause 8, wherein the second processing core is further configured to: access the first chunk of data based on the first indication from the one or more cache memories; and access the one or more second chunks of data and the third chunk of data based on the second indication from the one or more cache memories or from the one or more system memories.

Clause 11. The apparatus of Clause 8, wherein the one or more cache memories are one or more level 3 (L3) cache memories, and wherein the one or more system memories are one or more double data rate (DDR) memories.

Clause 12. The apparatus of any of Clauses 1-11, wherein the first processing core is configured to process image data.

Clause 13. The apparatus of Clause 11, wherein the first chunk of data comprises N number of lines of pixel data of an image.

Clause 14. The apparatus of any of Clauses 1-13, wherein the apparatus is part of an advanced driver assistance system (ADAS).

Clause 15. The apparatus of any of Clauses 1-14, wherein the apparatus is part of an extended reality (XR) or virtual reality (VR) system.

Clause 16. A method for interrupt handling, the method comprising: processing, by a first processing core, a first chunk of data; generating, by the first processing core, a first interrupt based on completing the process on the first chunk of data; processing, by the first processing core, one or more second chunks of data without generating an interrupt; receiving, by the first processing core, an acknowledgment of the first interrupt subsequent to processing the one or more second chunks of data; processing, by the first processing core, a third chunk of data; and generating, by the first processing core, a second interrupt based on completing the process on the third chunk of data.

Clause 17. The method of Clause 16, further comprising: receiving, by an inter-processor communication controller, the first interrupt for the first chunk of data; generating, by the inter-processor communication controller, a first indication available to a second processing core that indicates the first chunk of data is available; sending, by the inter-processor communication controller, a first acknowledgment to the first processing core indicating that the first interrupt was processed; receiving, by the inter-processor communication controller, the second interrupt for the third chunk of data; determining, by the inter-processor communication controller, that the third chunk of data and the one or more second chunks of data are available based on the third chunk of data being discontinuous with the first chunk of data; and generating, by the inter-processor communication controller, a second indication available to the second processing core that indicates the third chunk of data and the one or more second chunks of data are available.

Clause 18. The method of Clause 17, further comprising: sending, by the inter-processor communication controller, a second acknowledgment to the first processing core indicating that the second interrupt was processed.

Clause 19. The method of Clause 17, further comprising: processing, by the second processing core, the first chunk of data based on the first indication; and processing, by the second processing core, the one or more second chunks of data and the third chunk of data based on the second indication.

Clause 20. The method of Clause 19, further comprising: storing, by the first processing core, a first identification related to the first interrupt in an interrupt memory, wherein the first identification identifies the first chunk of data; storing, by the first processing core, a second identification related to the second interrupt in the interrupt memory, wherein the second identification identifies the third chunk of data; accessing, by the inter-processor communication controller, the first identification from the interrupt memory based on the first interrupt; and accessing, by the inter-processor communication controller, the second identification from the interrupt memory based on the second interrupt.

Clause 21. The method of Clause 20, further comprising: storing, by the first processing core, the first identification in a table in the interrupt memory; and storing, by the first processing core, the second identification in the table in the interrupt memory.

Clause 22. The method of Clause 20, further comprising: storing, by the first processing core, the first chunk of data in one or more cache memories after completing processing of the first chunk of data; and accessing, by the second processing core, the first chunk of data from the one or more cache memories based on the first indication that indicates the first chunk of data is available.

Clause 23. The method of Clause 22, further comprising: storing, by the first processing core, the one or more second chunks of data in the one or more cache memories or in one or more system memories based on a storage availability of the one or more cache memories.

Clause 24. The method of Clause 23, wherein the first processing core, the second processing core, the inter-processor communication controller, the interrupt memory, the one or more cache memories, and the one or more system memories are part of a system-on-chip (SOC) integrated circuit.

Clause 25. The method of Clause 23, further comprising: accessing, by the second processing core, the first chunk of data based on the first indication from the one or more cache memories; and accessing, by the second processing core, the one or more second chunks of data and the third chunk of data based on the second indication from the one or more cache memories or from the one or more system memories.

Clause 26. The method of Clause 23, wherein the one or more cache memories are one or more level 3 (L3) cache memories, and wherein the one or more system memories are one or more double data rate (DDR) memories.

Clause 27. The method of any of Clauses 16-26, wherein the first processing core is configured to process image data.

Clause 28. The method of Clause 27, wherein the first chunk of data comprises N number of lines of pixel data of an image.

Clause 29. A non-transitory computer-readable storage medium storing instructions that, when executed, cause one or more processors to: process a first chunk of data; generate a first interrupt based on completing the process on the first chunk of data; process one or more second chunks of data without generating an interrupt; receive an acknowledgment of the first interrupt subsequent to processing the one or more second chunks of data; process a third chunk of data; and generate a second interrupt based on completing the process on the third chunk of data.

Clause 30. An apparatus for interrupt handling, the apparatus comprising: means for processing a first chunk of data; means for generating a first interrupt based on completing processing the first chunk of data; means for processing one or more second chunks of data without generating an interrupt; means for receiving an acknowledgment of the first interrupt subsequent to processing the one or more second chunks of data; means for processing a third chunk of data; and means for generating a second interrupt based on completing the process on the third chunk of data.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. An apparatus for interrupt handling, the apparatus comprising:
one or more memories; and
a first processing core coupled to the one or more memories, the first processing core configured to:
process a first chunk of data;
generate a first interrupt based on completing the process on the first chunk of data;
process one or more second chunks of data without generating an interrupt;
receive an acknowledgment of the first interrupt subsequent to processing the one or more second chunks of data;
process a third chunk of data; and
generate a second interrupt based on completing the process on the third chunk of data.

2. The apparatus of claim 1, further comprising:
an inter-processor communication controller configured to:
receive the first interrupt for the first chunk of data;
generate a first indication available to a second processing core that indicates the first chunk of data is available;
send a first acknowledgment to the first processing core indicating that the first interrupt was processed;
receive the second interrupt for the third chunk of data;
determine that the third chunk of data and the one or more second chunks of data are available based on the third chunk of data being discontinuous with the first chunk of data; and
generate a second indication available to the second processing core that indicates the third chunk of data and the one or more second chunks of data are available.

3. The apparatus of claim 2, wherein the inter-processor communication controller is further configured to:
send a second acknowledgment to the first processing core indicating that the second interrupt was processed.

4. The apparatus of claim 2, further comprising:
the second processing core, wherein the second processing core is configured to:
process the first chunk of data based on the first indication; and
process the one or more second chunks of data and the third chunk of data based on the second indication.

5. The apparatus of claim 4, further comprising:
an interrupt memory;
wherein the first processing core is configured to store a first identification related to the first interrupt in the interrupt memory, wherein the first identification identifies the first chunk of data, and store a second identification related to the second interrupt in the interrupt memory, wherein the second identification identifies the third chunk of data, and
wherein the inter-processor communication controller is configured to access the first identification from the interrupt memory based on the first interrupt, and access the second identification from the interrupt memory based on the second interrupt.

6. The apparatus of claim 5, wherein the first processing core is configured to store the first identification and the second identification in a table in the interrupt memory.

7. The apparatus of claim 5, further comprising:
one or more cache memories,
wherein the first processing core is configured to store the first chunk of data in the one or more cache memories after completing processing of the first chunk of data, and
wherein the second processing core is configured to access the first chunk of data from the one or more cache memories based on the first indication that indicates the first chunk of data is available.

8. The apparatus of claim 7, further comprising:
one or more system memories,
wherein the first processing core is configured to store the one or more second chunks of data in the one or more cache memories or in the one or more system memories based on a storage availability of the one or more cache memories.

9. The apparatus of claim 8, wherein the first processing core, the second processing core, the inter-processor communication controller, the interrupt memory, the one or more cache memories, and the one or more system memories are part of a system-on-chip (SOC) integrated circuit.

10. The apparatus of claim 8, wherein the second processing core is further configured to:
access the first chunk of data based on the first indication from the one or more cache memories; and
access the one or more second chunks of data and the third chunk of data based on the second indication from the one or more cache memories or from the one or more system memories.

11. The apparatus of claim 8, wherein the one or more cache memories are one or more level 3 (L3) cache memories, and wherein the one or more system memories are one or more double data rate (DDR) memories.

12. The apparatus of claim 1, wherein the first processing core is configured to process image data.

13. The apparatus of claim 12, wherein the first chunk of data comprises N number of lines of pixel data of an image.

14. The apparatus of claim 1, wherein the apparatus is part of an advanced driver assistance system (ADAS).

15. The apparatus of claim 1, wherein the apparatus is part of an extended reality (XR) or virtual reality (VR) system.

16. A method for interrupt handling, the method comprising:
processing, by a first processing core, a first chunk of data;
generating, by the first processing core, a first interrupt based on completing the process on the first chunk of data;
processing, by the first processing core, one or more second chunks of data without generating an interrupt;
receiving, by the first processing core, an acknowledgment of the first interrupt subsequent to processing the one or more second chunks of data;
processing, by the first processing core, a third chunk of data; and
generating, by the first processing core, a second interrupt based on completing the process on the third chunk of data.

17. The method of claim 16, further comprising:
receiving, by an inter-processor communication controller, the first interrupt for the first chunk of data;
generating, by the inter-processor communication controller, a first indication available to a second processing core that indicates the first chunk of data is available;
sending, by the inter-processor communication controller, a first acknowledgment to the first processing core indicating that the first interrupt was processed;
receiving, by the inter-processor communication controller, the second interrupt for the third chunk of data;
determining, by the inter-processor communication controller, that the third chunk of data and the one or more second chunks of data are available based on the third chunk of data being discontinuous with the first chunk of data; and
generating, by the inter-processor communication controller, a second indication available to the second processing core that indicates the third chunk of data and the one or more second chunks of data are available.

18. The method of claim 17, further comprising:
sending, by the inter-processor communication controller, a second acknowledgment to the first processing core indicating that the second interrupt was processed.

19. The method of claim 17, further comprising:
processing, by the second processing core, the first chunk of data based on the first indication; and
processing, by the second processing core, the one or more second chunks of data and the third chunk of data based on the second indication.

20. The method of claim 19, further comprising:
storing, by the first processing core, a first identification related to the first interrupt in an interrupt memory, wherein the first identification identifies the first chunk of data;
storing, by the first processing core, a second identification related to the second interrupt in the interrupt memory, wherein the second identification identifies the third chunk of data;
accessing, by the inter-processor communication controller, the first identification from the interrupt memory based on the first interrupt; and
accessing, by the inter-processor communication controller, the second identification from the interrupt memory based on the second interrupt.

21. The method of claim 20, further comprising:
storing, by the first processing core, the first identification in a table in the interrupt memory; and
storing, by the first processing core, the second identification in the table in the interrupt memory.

22. The method of claim 20, further comprising:
storing, by the first processing core, the first chunk of data in one or more cache memories after completing processing of the first chunk of data; and
accessing, by the second processing core, the first chunk of data from the one or more cache memories based on the first indication that indicates the first chunk of data is available.

23. The method of claim 22, further comprising:
storing, by the first processing core, the one or more second chunks of data in the one or more cache memories or in one or more system memories based on a storage availability of the one or more cache memories.

24. The method of claim 23, wherein the first processing core, the second processing core, the inter-processor communication controller, the interrupt memory, the one or more cache memories, and the one or more system memories are part of a system-on-chip (SOC) integrated circuit.

25. The method of claim 23, further comprising:
accessing, by the second processing core, the first chunk of data based on the first indication from the one or more cache memories; and
accessing, by the second processing core, the one or more second chunks of data and the third chunk of data based on the second indication from the one or more cache memories or from the one or more system memories.

26. The method of claim 23, wherein the one or more cache memories are one or more level 3 (L3) cache memories, and wherein the one or more system memories are one or more double data rate (DDR) memories.

27. The method of claim 16, wherein the first processing core is configured to process image data.

28. The method of claim 27, wherein the first chunk of data comprises N number of lines of pixel data of an image.

29. A non-transitory computer-readable storage medium storing instructions that, when executed, cause one or more processors to:
process a first chunk of data;
generate a first interrupt based on completing the process on the first chunk of data;
process one or more second chunks of data without generating an interrupt;
receive an acknowledgment of the first interrupt subsequent to processing the one or more second chunks of data;
process a third chunk of data; and
generate a second interrupt based on completing the process on the third chunk of data.

30. An apparatus for interrupt handling, the apparatus comprising:
means for processing a first chunk of data;
means for generating a first interrupt based on completing processing the first chunk of data;
means for processing one or more second chunks of data without generating an interrupt;
means for receiving an acknowledgment of the first interrupt subsequent to processing the one or more second chunks of data;
means for processing a third chunk of data; and
means for generating a second interrupt based on completing the process on the third chunk of data.
